(19) United States
(12) Patent Application Publication
(10) Pub. No.: US 2005/0051003 A1
(43) Pub. Date: Mar. 10, 2005

(54) Cable fitting wrench

(76) Inventor: James Stern, Moundville, WV (US)

Correspondence Address: JAMES STERN, RD3, BOX 76FF, MOUNDSVILLE, WV, 26041, US

(21) Appl. No.: 10/654,043

(22) Filed: Sep. 4, 2003

(51) Int. Cl. B25B 13/56

(52) U.S. Cl. 81/176.3

(57) ABSTRACT

A cable fitting wrench, including a hinged 2-piece socket, that would allow individuals and technicians to easily locate, grip, and tighten or loosen the cable fitting on the back of a television or VCR. The cable fitting wrench would simply open in half around the cable fitting, then close and grip the fitting, and permitting the fitting to be easily inserted and tightened or loosened and removed from it's port.

### BACKGROUND OF THE INVENTION

With the increased installations of cable television in America, many individuals as well as cable television company technicians and installers, have discovered that is can be difficult to reach, grip properly and tighten or loosen the cable fitting on the back of a television or VCR.

There are several reasons for this. First, simply where the fitting is located on the back can be difficult to reach and properly grip. Secondly, many televisions and VCR's have recessed ports to help protect the fitting from damage. Also, most of the factory-made cable and wire fittings (which are most of the ones used) have a raised section just behind the fitting.

### SUMMARY OF THE INVENTION

The idea of the present invention is a cable fitting wrench, that would allow individuals and technicians to easily locate, grip, and tighten or loosen the cable fitting on the back of a television or VCR. The cable fitting wrench would simply open in half around the cable fitting, then close and grip the fitting, permitting the fitting to be easily inserted and tightened or loosened and removed from it's port.

### BRIEF DESCRIPTION OF THE DRAWINGS

FIG. 2 shows a top view of the invention;

FIG. 3 shows a cross-sectional view of the invention;

FIG. 4 shows a side view of the invention positioned around a fitting.

### DETAILED DESCRIPTION OF THE DRAWINGS

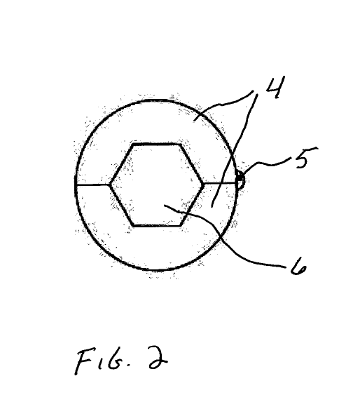

FIG. 2, #4 shows the two halves of the wrench. FIG. 2, #5 is where the hinge connects the two halves and allows opening and closing of the wrench. FIG. 2, #6 shows a standard 7/16″ fitting. Total width of the socket part should be around 1″, but may be different.

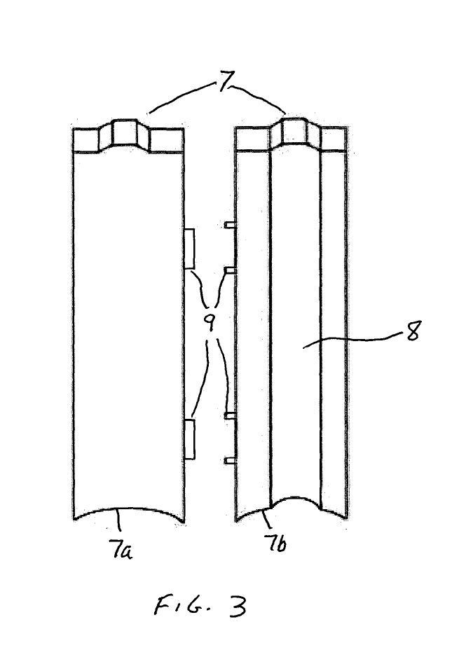

FIG. 3, #7 shows the two halves (7a and 7b) of the invention in an opened (detached) position. FIG. 3, #8 shows that the inside of part 7b is hollow to allow it to fit over fitting. This may also be true for part 7a as well. FIG. 3, #9 shows the hinges that connect the two halves, although other fastening/connecting devices may be used.

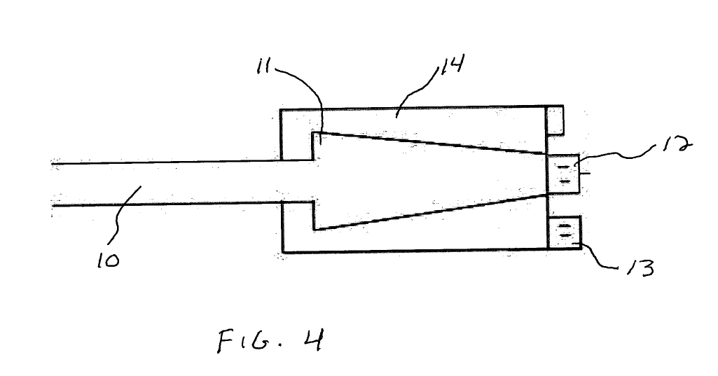

FIG. 4, #10 shows a standard cable wire, with a raised end (FIG. 4, #11), a 7/16″ fitting (FIG. 4, #12), and a 7/16″ inset to fit around fitting when closed round the end. FIG. 4, #14 is the wrench part in an open position.

1 A cable fitting wrench for allowing easy location, gripping, and tightening or loosening of a cable fitting to a television or VCR.

2 A cable fitting wrench as described in claim 1, whereas the wrench is in the form of two socket halves, attached by hinges.

3 A cable fitting wrench as described in claim 1, whereas one or both of the halves have a hollow body to allow the socket to fit around a cable wire and fitting.
